(19) United States
(12) Patent Application Publication
(10) Pub. No.: US 2004/0224816 A1
(43) Pub. Date: Nov. 11, 2004

(54) Gear with integrated angular position mechanism

(76) Inventors: Ken-Jen Lang, Bloomfield Hills, MI (US); Teresa Lang, Bloomfield Hills, MI (US); Xiaoyan Liu, Troy, MI (US); Chunhua Zhang, Troy, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/650,877

(22) Filed: Aug. 28, 2003

Related U.S. Application Data
(63) Continuation-in-part of application No. 10/430,573, filed on May 6, 2003.

(51) Int. Cl. B60K 1/02

(52) U.S. Cl. 477/3

(57) ABSTRACT

A system for determining the angular position of a drive shaft in a rotary power plant, such as an internal combustion engine. The system includes a gear having a plurality of circumferentially spaced teeth which is secured to the drive shaft for rotation therewith so that the angular position of the gear corresponds to the angular position of the drive shaft. At least one tooth of the gear has at least a portion that is constructed of one of a magnetic material or a non-magnetic material while the other teeth of the gear are constructed of the other of the magnetic material or non-magnetic material. A magnetic sensor is positioned adjacent the gear which generates an output signal when the tooth is in a predefined proximity of the sensor. Advantageously, the gear forms a combination flywheel and timing wheel for an internal combustion engine. A method for constructing the gear is also disclosed.

### RELATED APPLICATION

This application is a continuation-in-part of U.S. patent application Ser. No. 10/430,573 filed May 6, 2003.

### BACKGROUND OF THE INVENTION

I. Field of the Invention

The present invention relates generally to gears and, more particularly, to a gear with an integrated position mechanism for use in linear or rotary power plants, such as internal combustion engines.

II. Description of Related Art

There are many previously known rotary power plants, such as electric motors, electric generators, compressors and internal combustion engines. These rotary power plants typically have a drive shaft along which power from or to the rotary power plant is transmitted.

In order to ensure stable operation of the rotary power plant, it is conventional to attach a flywheel to the drive shaft. The flywheel is typically made of a heavy material, typically iron, steel or other ferrous material. Due to the weight of the flywheel, the flywheel ensures smooth operation of the rotary power plant.

In order for proper operation of the rotary power plant, especially for internal combustion engines, it is necessary to detect the angular position of the drive shaft during operation. The angular position of the drive shaft is then utilized by the control system for the rotary power plant, e.g. the ignition system and fuel injection system for an internal combustion engine, to ensure the proper timing combustion and the like for the rotary power plant.

Previously, these rotary power plants have utilized a separate timing wheel which is mechanically connected to the drive shaft so that the timing wheel rotates in unison with the drive shaft. However, these previously known timing wheels are not used to transmit power.

Since these previously known timing wheels are separate from the flywheel of the rotary power plant, the timing wheel necessarily entails an additional expense in the overall cost of the rotary power plant, takes space, and increases the weight.

### SUMMARY OF THE PRESENT INVENTION

The present invention provides a unique gear which forms a combination drive or driven gear, such as a flywheel and timing wheel which overcomes all of the above-mentioned disadvantages of the previously known devices.

In brief, the present invention comprises a gear having a plurality of circumferentially spaced teeth typically formed about the outer perimeter of the gear. The gear is secured to the drive shaft of the rotary power plant such that power is transmitted either to or from the power plant through both the drive shaft as well as the gear.

The gear is constructed of one of either a magnetic material or a non-magnetic material. Conversely, at least one tooth of the gear is replaced with a tooth constructed of a material which is the other of the magnetic material or the non-magnetic material. Any conventional means, such as press fitting, welding, brazing, gluing or the like, may be used to attach the tooth to the gear.

Alternatively, only a portion of the tooth is replaced and/or covered with the other of the magnetic material or non-magnetic material.

A sensor mounted to the rotary power plant is positioned adjacent the gear. Upon rotation of the gear, the sensor will detect the angular position of the gear whenever the sensor is aligned with the tooth either because the tooth is constructed of a non-magnetic material while the remainder of the teeth are constructed of a magnetic material, or vice versa. Since the gear is coupled to the drive shaft, the output from the sensor provides an output signal representative of the angular position of the gear and thus of the drive shaft. This signal of the angular position of the gear wheel is then used by the control system for the power plant to control, for example, engine ignition timing and the like.

A method for constructing the gear is also disclosed.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a perspective view illustrating a preferred embodiment of the present invention;

FIG. 2 is a fragmentary side view of the preferred embodiment of the present invention;

FIG. 3 is a fragmentary view taken substantially along line 3-3 in FIG. 2;

FIG. 4 is a diagrammatic view illustrating the preferred embodiment of the present invention;

FIG. 5 is an exemplary signal chart;

FIG. 6A is a fragmentary side view illustrating a modification of the present invention;

FIG. 6B is a view taken substantially along line 6B-6B in FIG. 6A;

FIG. 7A is a side view similar to FIG. 6A, but illustrating a modification thereof;

FIG. 7B is a view taken substantially along line 7B-7B in FIG. 7A;

FIG. 8A is a view similar to FIG. 6A, but illustrating a modification thereof;

FIG. 8B is a view taken substantially along line 8B-8B in FIG. 8A;

FIG. 9A is a view similar to FIG. 6A, but illustrating a modification thereof;

FIG. 9B is a view taken substantially along line 9B-9B in FIG. 9A;

FIG. 10A is a view similar to FIG. 6A, but illustrating a modification thereof;

FIG. 10B is a view taken substantially along line 10B-10B in FIG. 10A;

FIG. 11A is a view similar to FIG. 6A, but illustrating a modification thereof;

FIG. 11B is a view taken substantially along line 11B-11B in FIG. 11A;

FIG. 12A is a view similar to FIG. 6A, but illustrating a modification thereof;

FIG. 12B is a view taken substantially along 12B-12B in FIG. 12A; and

FIG. 13 is a diagrammatic view illustrating the method to generate desired teeth patterns by mean of changing the teeth's material.

### DETAILED DESCRIPTION OF PREFERRED EMBODIMENTS OF THE PRESENT INVENTION

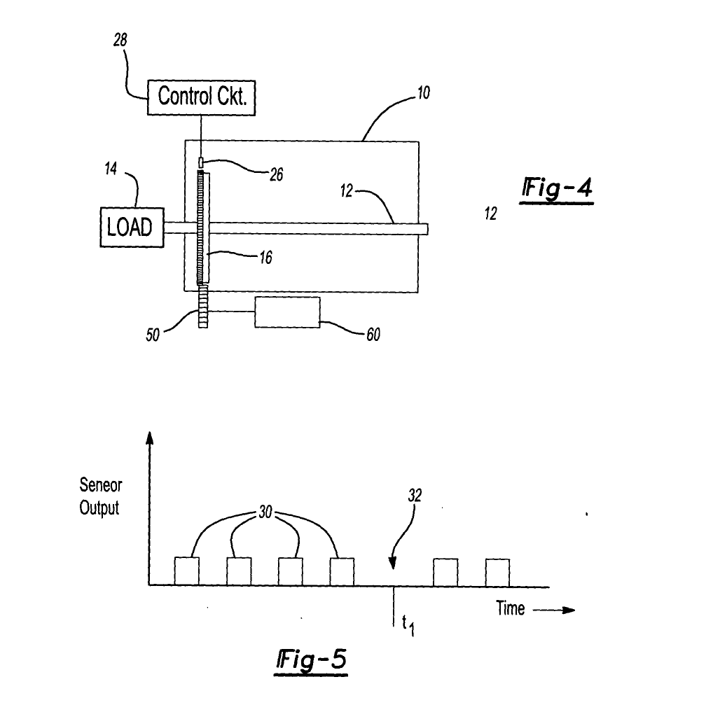

With reference first to FIG. 4, a rotary power plant 10, such as an electric motor, electric generator, internal combustion engine, compressor or the like, is shown diagrammatically. The rotary power plant 10 includes a drive shaft 12 through which power is transmitted to or from a second power source 60, also illustrated diagrammatically. A gear 16 is secured to the shaft 12 so that the gear 16 rotates in unison with the drive shaft 12. Consequently, the angular position of the gear 16 correlates to the angular position of the drive shaft 12. Furthermore, power is able to be transmitted from or to the drive shaft 12 through the gear 16.

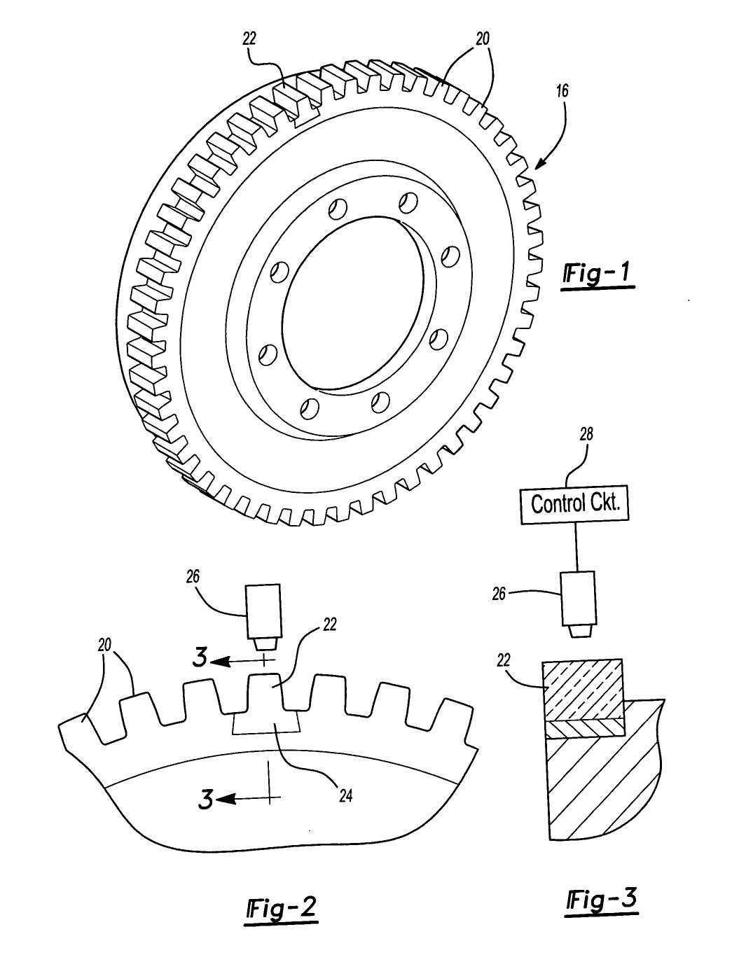

With reference now to FIG. 1, the gear 16 is shown in greater detail and is generally linear or annular in shape having a plurality of circumferentially spaced teeth 20 formed about its outer periphery. In operation, these teeth 20 of the gear 16 mesh with cooperating teeth on other gear 50 such that power is transmitted from or to the shaft 12 through the gear 16.

In the preferred embodiment of the invention, the gear 16 also forms the flywheel and timing wheel for the rotary power plant 10. As such, the gear 16 is constructed of a heavy material and typically a heavy ferrous material that is magnetic. In the well-known fashion, the gear 16, operating as a flywheel, ensures smooth operation of the rotary power plant 10 through the inertia of the gear 16 in the case of an internal combustion engine.

With reference now to FIGS. 1-3, at least one tooth 22 of the gear 16 is constructed of a material having opposite magnetic characteristics from the other teeth 20. For example, assuming that the other teeth 20 are constructed of a ferrous metal (magnetic material), the tooth 22 is constructed of a non-ferrous materials (magnetic material), such as stainless steel, aluminum, tungsten, nickel, bronze, and their alloys, ceramics, plastic, composite material, and the like. Conversely, if the teeth 20 of the gear 16 are constructed of a non-ferrous material, then the tooth 22 is constructed of ferrous material.

As best shown in FIG. 2, the tooth 22 has the same overall size and shape as the other teeth 20. As such, the tooth 22 is utilized to transmit power to or from the drive shaft 12 just as the other teeth 20 also transmit power to or from the drive shaft 12.

Any conventional means may be utilized to secure the tooth 22 to the gear 16. For example, the tooth 22 could be welded, brazed, glued or otherwise secured to the gear 16. Alternatively, the tooth 22 could be press fit into the gear 16 with an interference fit between the tooth 22 and gear 16. Additionally, as shown in FIG. 2, the tooth 22 may include a dovetail inner end 24 to assist in mechanically locking the tooth 22 to the gear 16.

With reference now to FIGS. 3 and 4, a sensor 26 is mounted to the power plant preferably at a position spaced radially outwardly from the teeth 20 as well as the tooth 22. This sensor 26 detects the presence of the all the teeth made of ferrous metal whenever the tooth is within a predefined proximity of the sensor 26, but the non-ferrous metal tooth. The sensor 26 then produces an output signal to a control circuit 28 for the rotary power plant 10 whenever the ferrous teeth pass sensor 26. Then from the intervals of the tooth signals, the location of the non-ferrous tooth can be obtained.

For example, in the event that the rotary power plant 10 comprises an internal combustion engine having a plurality of combustion chambers, the output signal from the sensor 26 corresponds to the angular position of the gear 16 and thus the angular position of the drive shaft 12. As such, the output signal from the sensor 26 to the control circuit can be used for multiple control functions, including engine ignition timing, speed measurement and control and the like.

With reference now to FIGS. 2 and 5, it will be understood that the sensor 26 may also detect the position of the tooth 22 by the absence of a signal from the sensor 26. Consequently, as used herein the phrase “generates a signal” when used in connection with the sensor 26 means both the generation of a signal as well as the absence of an output signal. For example, assuming that the teeth 20 of the gear 16 are constructed of a magnetic material and that the tooth 22 is constructed of a non-magnetic material, the sensor 26 may generate an output signal to the control circuit 28 whenever it is in close proximity to the teeth 20. Thus, as shown in FIG. 5, the sensor 26 will provide a plurality of spaced output pulses 30 with each pulse corresponding to the alignment of the sensor 26 with one of the teeth 20. However, when the sensor is aligned with the non-magnetic tooth 22 at time t₁, a space or absence of a signal 32 in the pulse train from the sensor output will occur and this space 32 at time t₁ is detected by the control circuit 28 as the position of the tooth 22 and thus of the angular position of the gear 16.

The control circuit 28 processes the output from the sensor 26 in any conventional fashion. A primary advantage of the gear 16 of the present invention is that the gear 16 forms a combination flywheel and timing wheel for the rotary power plant 10. As such, both the necessity and cost of a separate timing wheel utilized with the previously known power plant is entirely eliminated.

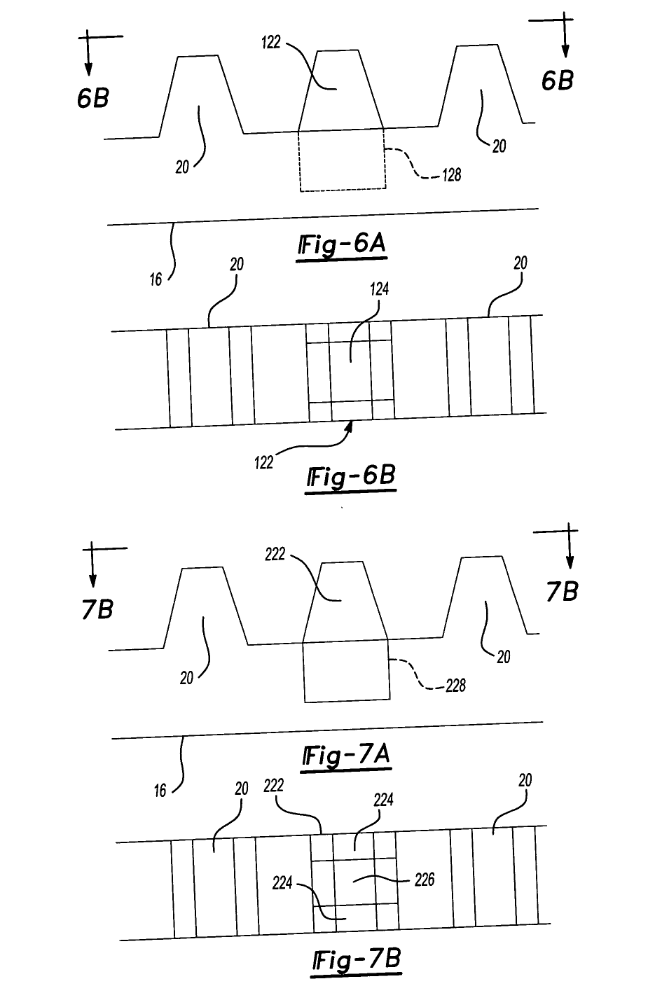

With reference now to FIGS. 6A and 6B, a modification of the gear 16 is shown in which the gear includes a plurality of teeth 20 (only two illustrated) having a first magnetic quality. At least one tooth 122 includes a central insert section 124 having magnetic qualities opposite from the teeth 20. Any conventional means may be used to secure the insert 124 to the tooth 122, such as gluing, welding, brazing, and the like.

With reference now to FIGS. 7A and 7B, a still further modification of the present invention is shown in which the gear includes a plurality of teeth 20 (only two illustrated) having a first magnetic characteristic. One tooth 222, however, includes two side plates 224 which are made of a material having an opposite magnetic characteristic from the teeth 20. Any conventional means may be used to secure the side plates 224 to the tooth 222, such as welding, gluing, brazing, and the like.

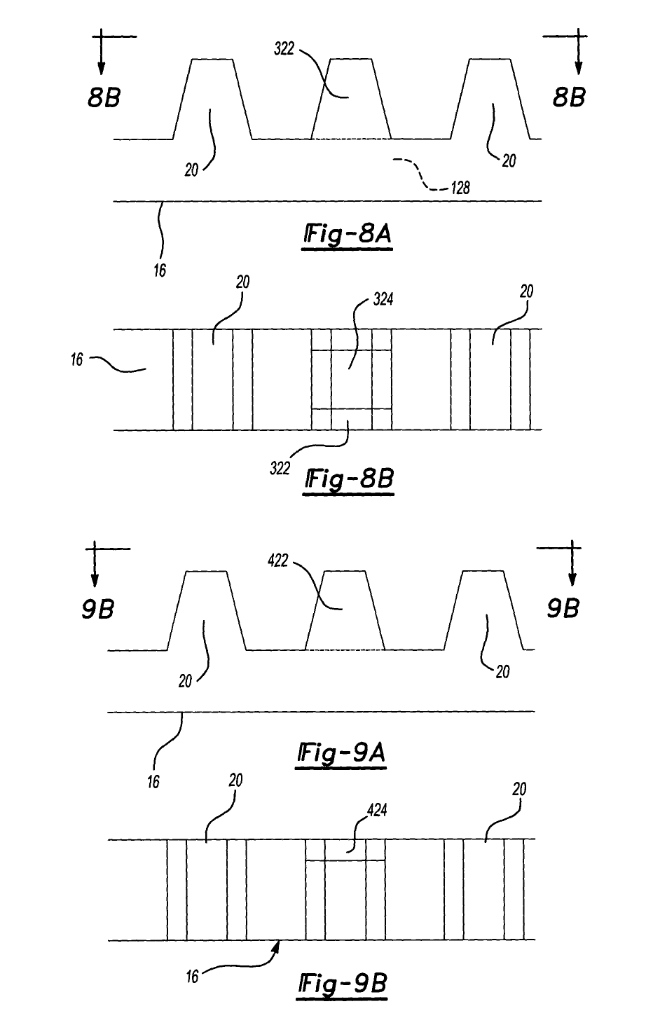

With reference now to FIGS. 8A and 8B, a still further modification of the invention is shown in which the gear wheel includes a plurality of teeth 20 (only two illustrated) having a first magnetic characteristic. One or more teeth 322 (only one illustrated) includes a central filling 324 which is made of a material having a magnetic characteristic opposite from the teeth 20. The embodiment of the invention illustrated in FIGS. 8A and 8B, furthermore, differs from that shown in FIGS. 6A and 6B in that the central filling 324 does not include a root which extends into the main body of the gear 16. Furthermore, any conventional means may be used to secure the central filling 324 to the tooth 322.

With reference now to FIGS. 9A and 9B, a still further modification of the invention is shown in which the gear wheel 16 includes a plurality of teeth 20 (only two illustrated) made of a material of a first magnetic characteristic. One or more teeth 422, however, include a partially modified tooth such as side insert 424 which is made of a material having the opposite magnetic characteristics from the teeth 20. Any conventional means may be used to secure the side insert 424 to the tooth 422.

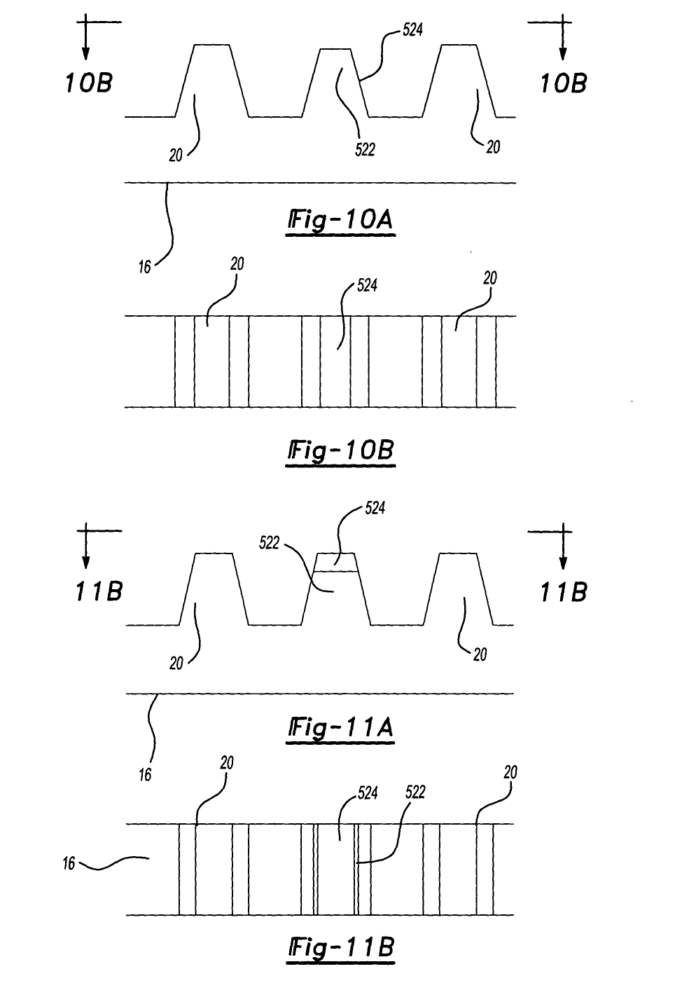

With reference now to FIGS. 10A and 10B, a still further modification of the invention is shown in which the gear 16 includes a plurality of teeth 20 (only two shown) constructed of a material having a first magnetic characteristic. A crown 524 is positioned over one or more of the teeth 522, and this crown 524 is constructed of a material having the opposite magnetic characteristics from the teeth 20. Any conventional means may be used to secure the crown 524 to the tooth 522.

With reference now to FIGS. 11A and 11B, a still further modification of the invention is shown in which the gear 16 includes a plurality of teeth 20 (only two shown) constructed of a material having a first magnetic characteristic. At least one tooth 522 includes an outer cap 524 which is constructed of a material having the opposite magnetic characteristic from the teeth 20. Any conventional means may be used to secure the cap 524 to the tooth 522.

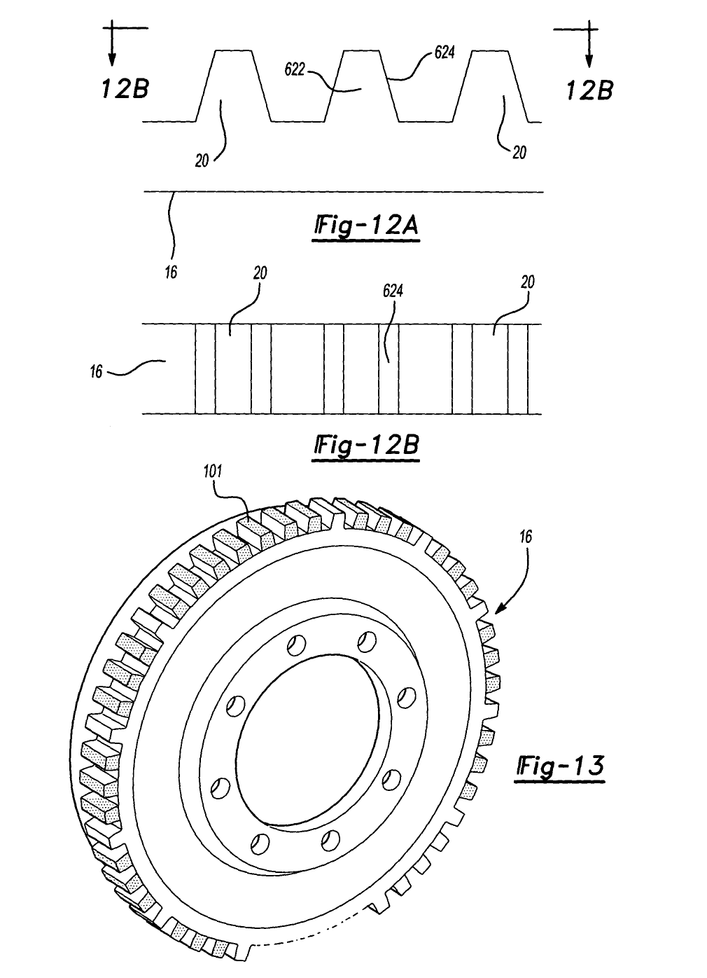

With reference now to FIGS. 12A and 12B, a still further modification of the present invention is shown in which the gear 16 includes a plurality of teeth 20 (only two shown) constructed of a material having a first magnetic characteristic. At least one of the teeth 622 has a partially or entirely coating 624 of a material having the opposite magnetic characteristics from the teeth 20. The area to be coated and the thickness of the coated layer can be determined by the application requirements. Any conventional means, such as electronic beam welding, laser beam welding, fusing, plating, electrodeposit or chemical deposit, or some of the combination of above may be used to coat the tooth 622 with the coating 624.

Since the teeth with non-ferrous metal are invisible to a magnetic pickup sensor, the teeth with non-ferrous materials not only can be used as position indicators, but also can be used for reducing the total number of effective tooth count to the sensor. For example, for a 144-tooth flywheel used in engine, if three of each four teeth are entirely or partially made with non-ferrous material as said, then the sensor will generate an output signal similar to a 36-tooth wheel. If one more tooth is partially or entirely made of non-ferrous material, then a 36-1 tooth pattern is formed as illustrated in FIG. 13. On the other hand, if the base flywheel with many teeth is made of non-ferrous material, only the 36-1 ferrous teeth can be placed on the flywheel as desired to form a 36-1 tooth pattern for engine angular position and speed detection purposes.

Although the present invention has been described for use with a rotary power plant, such as an electric motor, electric generator, internal combustion engine or compressor, no undue limitations should be drawn therefrom. Rather, the gear of the present invention will have many uses in other applications including linear gears.

Having described our invention, however, many modifications thereto will become apparent to those skilled in the art to which it pertains without deviation from the spirit of the invention as defined by the scope of the appended claims.

We claim:

1. For use in conjunction with a rotary power plant having a drive shaft, a system for determining the angular position of the drive shaft comprising:
a gear having a body and a plurality of circumferentially spaced teeth extending outwardly from said body, said gear being secured to the drive shaft for rotation therewith so that the angular position of the gear directly corresponds to the angular position of the drive shaft,
at least a portion of at least one tooth of said gear being constructed of one of a magnetic material or a non-magnetic material,
the other teeth of said gear being constructed of the other of the magnetic material or non-magnetic material,
a magnetic sensor positioned adjacent said gear which generates a signal when said at least one tooth is in a predefined proximity of said sensor.

2. The invention as defined in claim 1 wherein said rotary power plant comprises an internal combustion engine.

3. The invention as defined in claim 1 wherein said rotary power plant comprises an electric motor.

4. The invention as defined in claim 1 wherein said rotary power plant comprises an electric generator.

5. The invention as defined in claim 1 wherein said rotary power plant comprises a compressor.

6. The invention as defined in claim 2 wherein said gear comprises a flywheel.

7. The invention as defined in claim 1 wherein said non-magnetic material comprises a non-ferrous material.

8. The invention as defined in claim 1 wherein said magnetic material comprises a ferrous material.

9. The invention as defined in claim 1 wherein said portion of said at least one tooth comprises a root which extends into said gear wheel body.

10. The invention as defined in claim 9 wherein said portion of said at least one tooth includes a plurality of roots which extend into said gear wheel body.

11. The invention as defined in claim 9 wherein said root is aligned with a center of said at least one tooth.

12. The invention as defined in claim 9 wherein said root is positioned along a side of said at least one tooth.

13. The invention as defined in claim 1 wherein said portion of said at least one tooth comprises a radially outer portion of said at least one tooth.

14. The invention as defined in claim 1 wherein said portion of said at least one tooth comprises a crown disposed over and attached to said at least one tooth.

15. The invention as defined in claim 1 wherein said portion of said at least one tooth comprises a coating overlying at least a portion of said at least one tooth.

16. A method for making a gear having a plurality of circumferentially spaced teeth, said gear being made of one of a magnetic material or a non-magnetic material, said method comprising the steps of:
constructing at least a portion of at least one tooth from a material the other of the magnetic material or the non-magnetic material,
substituting said portion of at least one tooth for a corresponding portion of at least one corresponding tooth on the gear,
attaching said substituted portion of at least one tooth to the gear.

17. The invention as defined in claim 16 wherein said attaching step comprises gluing.

18. The invention as defined in claim 16 wherein said attaching step comprises welding.

19. The invention as defined in claim 16 wherein said attaching step comprises brazing.

20. The invention as defined in claim 16 wherein said attaching step comprises press fitting the at least one tooth to the gear.

21. The invention as defined in claim 16 wherein said attaching step comprises depositing, such as plating, fusing, electronic beam welding, and laser beam welding, said portion on said at least one tooth.

22. A combination flywheel and timing wheel for an internal combustion engine comprising:
a gear having a plurality of circumferentially spaced teeth, said gear being constructed of one of a magnetic material or a non-magnetic material,
at least a portion of at least one tooth of said gear being constructed of the other of the magnetic material or the non-magnetic material.

23. The teeth with non-ferrous metal not only can be used as position indicators, but also can be used for reducing the total number of effective teeth count to the sensor.
